(19) United States
(12) Patent Application Publication
(10) Pub. No.: US 2026/0359693 A1
(43) Pub. Date: Nov. 12, 2026

(54) QUANTUM COMPUTER SCHEDULING METHOD FOR UTILIZING AN OPTIMAL QUANTUM COMPUTER

(71) Applicant: NORMA inc., Seoul (KR)

(72) Inventors: Hyunchul JUNG, Seoul (KR); Chang Nyoung SONG, Seoul (KR)

(21) Appl. No.: 19/650,370

(22) Filed: Apr. 17, 2026

(30) Foreign Application Priority Data
May 7, 2025 (KR) 10-2025-0058932
Jul. 28, 2025 (KR) 10-2025-0102425

(51) Int. Cl. G06N 10/20; G06F 9/50

(52) U.S. Cl. CPC G06N 10/20; G06F 9/5027

(57) ABSTRACT

The technical spirit of the present invention relates to a quantum computer scheduling method for utilizing an executing quantum computer. According to one embodiment of the present disclosure, a quantum computer scheduling method performed by at least one processor may include collecting specification information on a plurality of quantum computers; receiving, from a user, an execution request for a quantum circuit; obtaining requirement information from the execution request; selecting at least one executable quantum computer from among the plurality of quantum computers by comparing the requirement information with the specification information; selecting an executing quantum computer from among the at least one executable quantum computer; and assigning the quantum circuit to the executing quantum computer.

### CROSS-REFERENCE TO RELATED APPLICATION

This application claims priority to and the benefit of Korean Patent Application No. 10-2025-0058932, filed on May 7, 2025, and Korean Patent Application No. 10-2025-0102425, filed on Jul. 28, 2025, the disclosures of which are incorporated herein by reference in their entirety.

### BACKGROUND

### Technical Field

The present disclosure relates to a quantum computer scheduling method for utilizing an optimal quantum computer.

### Background Art

Recently, as quantum computers have begun to be commercialized in earnest, various types of quantum computers are being provided on a cloud basis. Through such a quantum cloud platform, a user may develop a quantum algorithm or a quantum circuit and process the same by selecting an available quantum computer for execution. However, each quantum computer has various different characteristics, such as the number of qubits, qubit type, gate fidelity, T1 and T2 times, operating status, job queue status, and usage cost, and such characteristics directly affect execution accuracy and processing time of a circuit.

In a current quantum cloud environment, there is an inconvenience in that a user must directly compare such hardware-specific details and individually select a quantum computer most suitable for characteristics of a circuit. In particular, in a situation where an understanding of performance differences and characteristics among heterogeneous quantum computers (e.g., a superconducting type and an ion trap type) is required, it is difficult to select an optimal device without specialized knowledge. In addition, when a device having low fidelity or short T1/T2 times is selected, an error probability during execution of the circuit may increase, and reliability of a result may be degraded.

Accordingly, there is a need for a scheduling scheme capable of automatically analyzing a quantum circuit created by a user, selecting, from among a plurality of quantum computers connected to a cloud, a device most suitable for characteristics and requirements of the circuit, automatically utilizing the selected device, or recommending the selected device to the user.

### SUMMARY

### Technical Problem

An object of the present invention is to provide a quantum computer scheduling method for filtering quantum computers suitable for a user's request and utilizing an optimal quantum computer.

Another object of the present invention is to provide a quantum computer scheduling method for selecting an optimal quantum computer in consideration of a user's needs.

### Technical Solution

According to an embodiment of the present disclosure, a quantum computer scheduling method performed by at least one processor may include collecting specification information on a plurality of quantum computers; receiving, from a user, an execution request for a quantum circuit; obtaining requirement information from the execution request; selecting at least one executable quantum computer from among the plurality of quantum computers by comparing the requirement information with the specification information; selecting an executing quantum computer from among the at least one executable quantum computer; and assigning the quantum circuit to the executing quantum computer.

In one embodiment, the quantum circuit may include a first quantum line representing a quantum state of a first qubit; a second quantum line representing a quantum state of a second qubit; and a quantum gate configured to perform an operation on at least one of the first qubit and the second qubit.

In one embodiment, the quantum gate may include a Pauli gate for exchanging state probabilities corresponding to “0” or “1” of a qubit or changing a probability amplitude or a probability phase; a Hadamard gate for fixing a qubit in a superposition state of “0” and “1”; a CNOT gate for placing a plurality of qubits in an entangled state; a SWAP gate for swapping states of a plurality of qubits; a Toffoli gate for inverting a state of a third qubit based on states of a first qubit and a second qubit; and a Fredkin gate for swapping states of a second qubit and a third qubit based on a state of a first qubit.

In one embodiment, the requirement information may include an execution mode relating to a method of selecting a quantum computer for execution, and the execution mode may include a target mode configured to receive, from a user, information on a quantum computer for execution; an optimal cost mode configured to select the executing quantum computer in consideration of a cost for executing the quantum circuit; an optimal time mode configured to select the executing quantum computer in consideration of a time for executing the quantum circuit; and an optimal device mode configured to select the executing quantum computer in consideration of a plurality of factors for executing the quantum circuit.

In one embodiment, the selecting of the executing quantum computer from among the at least one executable quantum computer may include, when the execution mode is the optimal cost mode, obtaining, for each of the at least one executable quantum computer, estimated processing time for the quantum circuit; obtaining, from a cost database, processing cost information corresponding to each of the at least one executable quantum computer; obtaining, using the estimated processing time and the processing cost information, an estimated cost corresponding to each of the at least one executable quantum computer; and selecting the executing quantum computer based on the estimated cost.

In one embodiment, the obtaining of the estimated processing time for the quantum circuit for each of the at least one executable quantum computer may include performing a simulation on the quantum circuit using a simulator corresponding to the at least one executable quantum computer; and obtaining the estimated processing time as a result of the simulation.

In one embodiment, the obtaining of the estimated processing time for the quantum circuit for each of the at least one executable quantum computer may include identifying at least one gate included in the quantum circuit; obtaining, from a gate-specific processing time database corresponding to the at least one executable quantum computer, gate-specific processing time for the at least one gate; and obtaining the estimated processing time by summing all of the gate-specific processing times.

In one embodiment, the selecting of the executing quantum computer from among the at least one executable quantum computer may include, when the execution mode is the optimal time mode, obtaining, for each of the at least one executable quantum computer, waiting time corresponding to time associated with a job waiting in a current queue; obtaining, for each of the at least one executable quantum computer, estimated processing time for the quantum circuit; obtaining estimated completion time by summing the waiting time and the estimated processing time; and selecting the executing quantum computer based on the estimated completion time.

In one embodiment, the selecting of the executing quantum computer from among the at least one executable quantum computer may include, when the execution mode is the optimal device mode, obtaining, for each of the at least one executable quantum computer, estimated cost; obtaining, for each of the at least one executable quantum computer, estimated completion time; obtaining, for each of the at least one executable quantum computer, fidelity information; obtaining, for each of the at least one executable quantum computer, selected device history indicating devices previously selected by the user; and selecting the executing quantum computer based on the estimated cost, the estimated completion time, the fidelity information, and the selected device history.

In one embodiment, the selecting of the executing quantum computer based on the estimated cost, the estimated completion time, the fidelity information, and the selected device history may include assigning a first score for each range of the estimated cost; assigning a second score for each range of the estimated completion time; assigning a third score for each range of the fidelity information; assigning a fourth score for each number of selections based on the selected device history; and selecting the executing quantum computer based on a summed score for the first score to the fourth score.

In one embodiment, the selecting of the at least one executable quantum computer may include obtaining, from the plurality of quantum computers, regional information indicating regions in which the plurality of quantum computers are located; and providing the regional information to a user.

In one embodiment, the selecting of the at least one executable quantum computer may include obtaining, as the requirement information, a required number of qubits, required fidelity information, a required T1 time, and a required T2 time; obtaining, as the specification information, a provided number of qubits, device fidelity information, a device T1 time, and a device T2 time; and selecting, as the at least one executable quantum computer, a quantum computer in which the provided number of qubits, the device fidelity information, the device T1 time, and the device T2 time satisfy the required number of qubits, the required fidelity information, the required T1 time, and the required T2 time, respectively.

### Effects of the Invention

According to the technical spirit of the present invention, tests may be performed for each driving condition using a quantum simulator with respect to quantum gates constituting a quantum circuit, and results of the tests may be stored in a database, so that a user may identify an optimal simulator before driving the simulator and may predict processing time. In addition, by performing a simulation using the determined optimal simulator, an optimal quantum circuit may be designed before utilizing a quantum computer, and, as a result, the quantum computer, which is a limited and expensive resource, may be efficiently utilized.

### BRIEF DESCRIPTION OF THE DRAWINGS

FIG. 1 is a block diagram illustrating a quantum computing system according to an exemplary embodiment of the present disclosure.

FIG. 2 is a flowchart illustrating a quantum computer scheduling method according to an exemplary embodiment of the present disclosure.

FIG. 3 is a diagram illustrating a quantum circuit according to an exemplary embodiment of the present disclosure.

FIG. 4 is a flowchart illustrating a quantum computer scheduling method according to an exemplary embodiment of the present disclosure.

FIG. 5 is a table illustrating a quantum computer database according to an exemplary embodiment of the present disclosure.

FIG. 6 is a flowchart illustrating a quantum computer scheduling method according to an exemplary embodiment of the present disclosure.

FIG. 7 is a flowchart illustrating a quantum computer scheduling method according to an exemplary embodiment of the present disclosure.

FIG. 8 is a flowchart illustrating a quantum computer scheduling method according to an exemplary embodiment of the present disclosure.

FIG. 9 is a flowchart illustrating a quantum computer scheduling method according to an exemplary embodiment of the present disclosure.

FIG. 10 is a flowchart illustrating a quantum computer scheduling method according to an exemplary embodiment of the present disclosure.

FIG. 11 is a flowchart illustrating a quantum computer scheduling method according to an exemplary embodiment of the present disclosure.

FIG. 12 is a block diagram illustrating a computing system according to an exemplary embodiment of the present disclosure.

### DETAILED DESCRIPTION

Hereinafter, preferred embodiments of the present invention will be described in detail with reference to the accompanying drawings. Advantages and features of the present invention, and methods for achieving the same, will become more apparent from the following embodiments described in detail in conjunction with the accompanying drawings. However, the technical spirit of the present invention is not limited to the following embodiments and may be embodied in various other forms. Rather, the following embodiments are provided so that the technical spirit of the present invention will be thorough and complete, and so that those of ordinary skill in the art to which the present invention pertains will fully understand the scope of the present invention. The technical spirit of the present invention is defined only by the scope of the claims.

In assigning reference numerals to elements in the drawings, it should be noted that like elements are designated by like reference numerals wherever possible even though such like elements are shown in different drawings. In addition, in describing the present invention, when it is determined that a detailed description of a related known configuration or function may obscure the gist of the present invention, a detailed description thereof will be omitted.

Unless otherwise defined, all terms used herein, including technical and scientific terms, have meanings commonly understood by those of ordinary skill in the art to which the present invention pertains. In addition, terms defined in generally used dictionaries should not be interpreted in an idealized or overly formal sense unless clearly and specifically defined otherwise. The terms used herein are for describing the embodiments and are not intended to limit the present invention. As used herein, the singular form includes the plural form unless the context clearly indicates otherwise.

In addition, in describing constituent elements of the present invention, terms such as first, second, A, B, (a), and (b) may be used. These terms are used only to distinguish one constituent element from another constituent element, and do not limit the nature, order, or sequence of the constituent elements. When one constituent element is described as being “connected,” “coupled,” or “linked” to another constituent element, it should be understood that the one constituent element may be directly connected or linked to the other constituent element, but that another constituent element may also be “connected,” “coupled,” or “linked” between the constituent elements.

As used in the present invention, “comprises” and/or “comprising” do not exclude the presence or addition of one or more other constituent elements, steps, operations, and/or elements in addition to the stated constituent elements, steps, operations, and/or elements.

A constituent element included in any one embodiment and a constituent element having a common function may be described using the same name in another embodiment. Unless stated otherwise, a description given in any one embodiment may also be applied to another embodiment, and a detailed description may be omitted to the extent of overlapping subject matter or to the extent that those of ordinary skill in the art can readily understand the same.

Hereinafter, the present invention will be described in detail with reference to preferred embodiments of the present invention and the accompanying drawings.

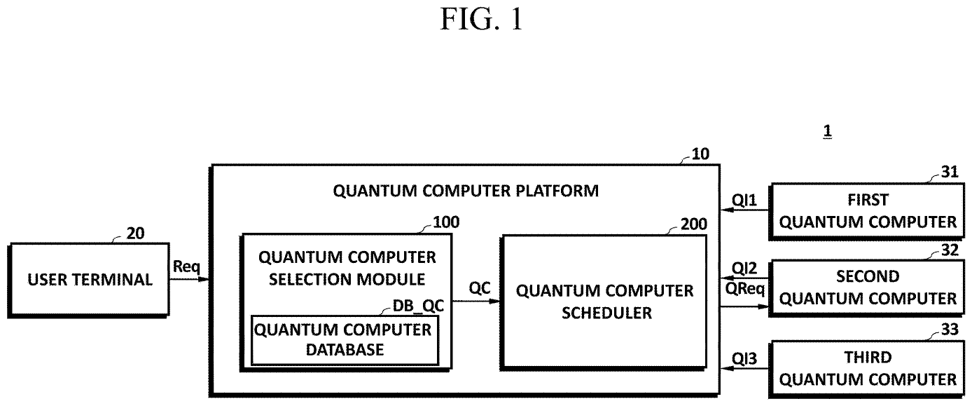

FIG. 1 is a block diagram illustrating a quantum computing system according to an exemplary embodiment of the present disclosure.

Referring to FIG. 1, a quantum computing system 1 may include a quantum computer platform 10, a user terminal 20, and a plurality of quantum computers 31, 32, and 33.

The user terminal 20 may be operated by a user who intends to design a quantum circuit, simulate the designed quantum circuit, and then perform computation using the actual quantum computers 31, 32, and 33, and may include various communication-capable terminal devices, such as a cellular phone, a smart phone, a laptop, a personal computer (PC), a navigation device, a personal communication system (PCS), a global system for mobile communications (GSM), a personal digital cellular (PDC), a personal handyphone system (PHS), a personal digital assistant (PDA), an international mobile telecommunication (IMT)-2000 terminal, a code division multiple access (CDMA)-2000 terminal, a W-code division multiple access (W-CDMA) terminal, a wireless broadband Internet (Wibro) terminal, a smart pad, and a tablet PC.

Each of the quantum computers 31, 32, and 33 is a computing device that processes information based on principles of quantum mechanics and, unlike a classical computer, represents and processes information in units of qubits rather than bits. A qubit may provide computational performance superior to that of a classical computer in certain computations by utilizing a superposition state in which states 0 and 1 coexist and an entanglement state among multiple qubits. Each of the plurality of quantum computers 31, 32, and 33 may represent a different device operated by a different entity, and supported computation schemes, specifications, and the like may differ depending on characteristics of the corresponding device.

The quantum computer platform 10 may perform various operations related to quantum computing under control of the user terminal 20 and, in one example, may be implemented in a cloud. In one embodiment, the quantum computer platform 10 may provide, to a user, a software development kit based on a quantum library for designing a quantum circuit. A software development kit (SDK) is a collection of software development tools developed for designing and simulating a quantum circuit. The SDK may include an application programming interface (API), libraries, development tools, documentation, example code, and the like to support a user in easily and quickly developing a quantum circuit. Through this, the user may build an application without having to deeply understand basic settings or functions of the platform, and the development process may be simplified and accelerated. The quantum computer platform 10 may perform various operations related to quantum computing by using application programs such as a website or an application.

The quantum computer platform 10 may include a quantum computer selection module 100 and a quantum computer scheduler 200. The quantum computer selection module 100 and the quantum computer scheduler 200 may be implemented as software modules or hardware modules, and may be operated by one or more servers.

The quantum computer selection module 100 may receive an execution request Req for a quantum circuit from the user terminal 20 and may obtain requirement information from the execution request Req. As used herein, the requirement information refers to various constraints required by the user terminal 20 for executing the quantum circuit (or for performing computation on the quantum circuit), and may include the number of qubits, fidelity, a T1 time, and a T2 time. The quantum computer selection module 100 may collect specification information QI1, QI2, and QI3 from the plurality of quantum computers 31, 32, and 33. As used herein, the specification information refers to various numerical values relating to capabilities of each quantum computer, and may include the number of processable qubits, fidelity, a T1 time, and a T2 time. The quantum computer selection module 100 may store the collected specification information in a quantum computer database DB_QC.

The quantum computer selection module 100 may select an executable quantum computer that satisfies the requirement information based on the specification information QI1, QI2, and QI3 in the quantum computer database DB_QC. In addition, the quantum computer selection module 100 may transmit information on the selected executable quantum computer QC to the quantum computer scheduler 200.

According to one embodiment of the present disclosure, the quantum computer selection module 100 may preliminarily select, as the executable quantum computer, a quantum computer that satisfies requirements requested by the user terminal 20 based on the requirement information and the specification information, and as a result, computation using a quantum computer that meets conditions desired by the user may be performed.

The quantum computer scheduler 200 may determine an optimal quantum computer from among the executable quantum computers QC. In one embodiment, the quantum computer scheduler 200 may receive information on an execution mode from the execution request Req and may recommend the optimal quantum computer in various manners based on the execution mode.

According to one embodiment of the present disclosure, because the quantum computer scheduler 200 recommends the optimal quantum computer based on the execution mode, a quantum computer optimal for a user's intended purpose may be recommended, and as a result, the user may utilize the quantum computer in a desired manner.

The quantum computer scheduler 200 may enable computation on the quantum circuit by transmitting a quantum circuit execution request QReq to the determined optimal quantum computer (for example, the second quantum computer 32).

Each component of the quantum computing system 1 may be connected so as to be able to communicate with one another through wired or wireless communication. When connected through wired communication, the respective components included in the quantum computing system 1 may communicate using a serial scheme. When connected through wireless communication, the respective components included in the quantum computing system 1 may communicate with one another using a wireless communication network. The wireless communication network may include, but is not limited to, a local area network (LAN), a wide area network (WAN), the World Wide Web (WWW), a wired or wireless data communication network, a telephone network, a wired or wireless television communication network, 3G, 4G, 5G, 3GPP (3rd Generation Partnership Project), 5GPP (5th Generation Partnership Project), LTE (Long Term Evolution), WIMAX (World Interoperability for Microwave Access), Wi-Fi, the Internet, a wireless LAN, a personal area network (PAN), a radio frequency (RF) network, a Bluetooth network, a near-field communication (NFC) network, a satellite broadcasting network, an analog broadcasting network, and a digital multimedia broadcasting (DMB) network.

As used herein, operation of the quantum computing system 1 and components included therein may refer to operations performed by a processor included in each component based on a computer program including at least one instruction stored in a storage device included in the corresponding component, and the storage device may include a non-volatile memory, a volatile memory, a flash memory, a hard disk drive (HDD), or a solid state drive (SSD). In addition, the processor may include at least one of a central processing unit (CPU), a graphic processing unit (GPU), a neural processing unit (NPU), a random access memory (RAM), a read-only memory (ROM), a system bus, and an application processor.

Although FIG. 1 discloses a feature of performing scheduling for three quantum computers, this is merely one example, and it will be readily understood that the technical spirit of the present disclosure may also be applied to embodiments in which scheduling is performed for more or fewer than three quantum computers.

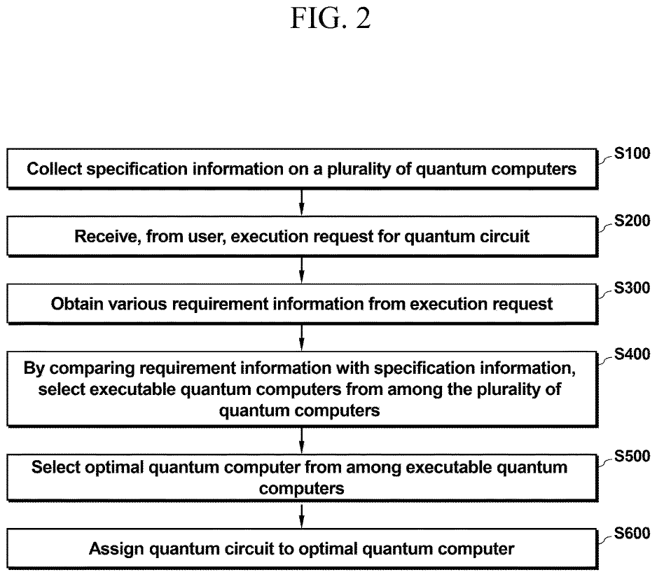

FIG. 2 is a flowchart illustrating a quantum computer scheduling method according to an exemplary embodiment of the present disclosure.

Referring to FIG. 2, the quantum computer platform 10 may generate a quantum computer database by collecting specification information on a plurality of quantum computers (S100). The quantum computer platform 10 may receive, from a user, an execution request for a quantum circuit (S200) and may obtain various requirement information from the execution request (S300). By comparing the requirement information with the specification information, the quantum computer platform 10 may select, from among the plurality of quantum computers, executable quantum computers (S400). In addition, the quantum computer platform 10 may select an optimal quantum computer from among the executable quantum computers (S500), and may assign the quantum circuit to the optimal quantum computer and transmit an execution request for processing the quantum circuit (S600).

According to the technical spirit of the present disclosure, the quantum computer platform 10 may first select executable quantum computers and then select an optimal quantum computer according to various conditions, thereby enabling a user to obtain a desired result by using a quantum computer optimal for the quantum circuit and the various conditions.

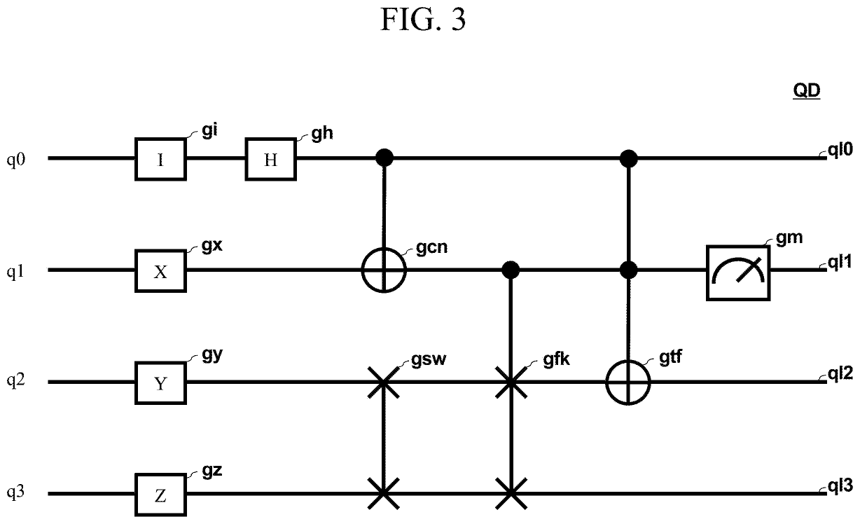

FIG. 3 is a diagram illustrating a quantum circuit according to an exemplary embodiment of the present disclosure.

Referring to FIG. 3, the quantum circuit QD may include a plurality of quantum lines q10 to q13 and a plurality of quantum gates. Each of the plurality of quantum lines q10 to q13 may correspond to qubits q0 to q3 and may represent an input to and an output from a quantum gate. The quantum gates may include Pauli gates including an I gate gi, an X gate gx, a Y gate gy, and a Z gate gz. The I gate, or identity gate, is a gate that leaves a qubit state unchanged in quantum computing. This gate is used when no operation is to be applied in a quantum circuit. The I gate is represented by a 2×2 identity matrix, which maintains the qubit state unchanged. A matrix representation of the I gate is shown in Equation 1.

$$( \begin{matrix}1 & 0 \\ 0 & 1\end{matrix} ) \qquad [ Equation 1 ]$$

The X gate gx performs a role similar to that of a classical NOT gate. This gate flips a state of a qubit. That is, a matrix representation of the X gate is shown in Equation 2.

$$( \begin{matrix}0 & 1 \\ 1 & 0\end{matrix} ) \qquad [ Equation 2 ]$$

The Y gate gy applies a complex phase transformation to a qubit. The Y gate gy is also equivalent to a combination of the X gate gx and the Z gate gz, and may change a phase of a quantum state through this gate. A matrix representation of the Y gate is shown in Equation 3.

$$( \begin{matrix}0 & - i \\ i & 0\end{matrix} ) \qquad [ Equation 3 ]$$

The Z gate gz changes a phase only for a “1” state. The Z gate gz leaves a “0” state unchanged and adds a phase of π to the “1” state. This serves to invert a phase of a qubit. A matrix representation of the Z gate gz is shown in Equation 4.

$$( \begin{matrix}1 & 0 \\ 0 & - 1\end{matrix} ) \qquad [ Equation 4 ]$$

The Hadamard gate gh is an important single-qubit transformation gate used in quantum computing. This gate is used to transform a qubit into a superposition state and provides a basis for quantum parallelism and entanglement. The Hadamard gate gh may be represented by Equation 5 below.

$$\frac{1}{\sqrt{2}} ( \begin{matrix}1 & 1 \\ 1 & - 1\end{matrix} ) \qquad [ Equation 5 ]$$

The CNOT (controlled-NOT) gate gen is a two-qubit gate. As a conditional gate, the CNOT gate gen applies a NOT operation (an X gate) to one qubit (a target qubit) according to a state of another qubit (a control qubit). The state of the target qubit is inverted only when the control qubit is in a “1” state. When the control qubit is in a “0” state, the target qubit remains unchanged.

The SWAP gate gsw is a two-qubit gate used to exchange states of two qubits with each other. The SWAP gate gsw is used when information is exchanged between two qubits, and through this, positions of the qubits within a quantum circuit may be adjusted. When applied to a two-qubit system, the SWAP gate transfers a state of a first qubit to a second qubit and transfers a state of the second qubit to the first qubit. The SWAP gate gsw may be represented by Equation 6 below.

$$( \begin{matrix}1 & 0 & 0 & 0 \\ 0 & 0 & 1 & 0 \\ 0 & 1 & 0 & 0 \\ 0 & 0 & 0 & 1\end{matrix} ) \qquad [ Equation 6 ]$$

The Fredkin gate gfk, or CSWAP (controlled-SWAP) gate, is a three-qubit gate including one control qubit and two target qubits. States of the two target qubits are exchanged with each other only when the control qubit is in a “1” state. When the control qubit is in a “0” state, the target qubits remain unchanged. The Fredkin gate gfk is particularly used to perform a conditional swap operation in quantum computing.

The Toffoli gate gtf, or CCNOT (controlled-controlled-NOT) gate, is a three-qubit gate including two control qubits and one target qubit. This gate applies a NOT operation to the target qubit only when both control qubits are in a “1” state. In all other cases, the target qubit remains unchanged. The Toffoli gate gtf may be used to perform a classical “AND” operation in quantum computing and is essential for implementing complex conditional operations in quantum algorithms.

The measurement gate gm is a gate for measuring a state of a qubit on the corresponding quantum line.

According to the technical spirit of the present disclosure, various gates and quantum lines shown in FIG. 3 may be provided to the user terminal 20 by a quantum library, and the user terminal may design a desired quantum circuit QD using the quantum library. Although representative gates are shown in FIG. 3, this is merely one example, and a greater variety of quantum gates than those shown may be included in the quantum library, and more or fewer qubits than the illustrated number of qubits (four) may be provided by the SDK.

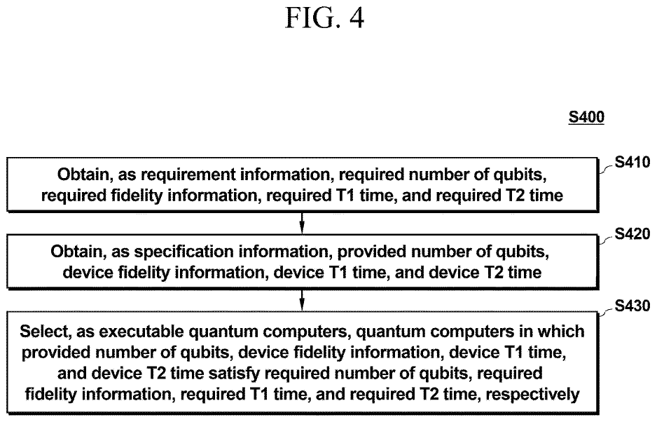

FIG. 4 is a flowchart illustrating a quantum computer scheduling method according to an exemplary embodiment of the present disclosure. More specifically, FIG. 4 illustrates step S400 of selecting executable quantum computers in FIG. 2.

Referring to FIG. 4, the quantum computer platform 10 may obtain, as requirement information, a required number of qubits, required fidelity information, a required T1 time, and a required T2 time (S410). Fidelity is one of the primary indicators for evaluating performance of a quantum computer, and is a value quantitatively representing similarity between a theoretically expected quantum state and an actually implemented quantum state. Fidelity is generally expressed as a real value between 0 and 1, and a value closer to 1 indicates that the quantum state has been implemented more closely to an ideal quantum state. As used herein, the fidelity information includes fidelities measured for various operations, such as a single-qubit gate, a two-qubit gate, and measurement.

T1 time (relaxation time) refers to an average time taken for a qubit to naturally relax from a high-energy state (e.g., a |1> state) to a low-energy state (e.g., a |0>state). This represents a phenomenon in which the qubit returns to its original state while releasing energy to an external environment, and directly affects retention time of a quantum state. As the T1 time increases, the qubit may stably retain quantum information for a longer period of time.

T2 time (dephasing time) refers to an average time taken for phase information of a qubit to be lost due to external noise or the like. This is an indicator indicating how long coherence between qubits is maintained, and corresponds to a time during which correlation between qubits is maintained during a quantum operation. In practice, the T2 time is often less than or equal to the T1 time. In an ideal case, however, T2 may approach twice T1.

The quantum computer platform 10 may obtain, as specification information, a provided number of qubits, device fidelity information, a device T1 time, and a device T2 time (S420). In one embodiment, the quantum computer platform 10 may request and obtain specification information from a plurality of quantum computers in advance and may store the obtained specification information in the quantum computer database DB_QC.

The quantum computer platform 10 may select, as executable quantum computers, quantum computers in which the provided number of qubits, the device fidelity information, the device T1 time, and the device T2 time satisfy a required number of qubits, required fidelity information, a required T1 time, and a required T2 time, respectively (S430).

According to one embodiment of the present disclosure, requirement information may be received from the user terminal 20, and quantum computers satisfying the requirement information may be filtered in advance using the quantum computer database DB_QC, so that a quantum computer suitable for a level desired by a user may be scheduled.

Although FIG. 4 illustrates an example in which the number of qubits, fidelity information, a T1 time, and a T2 time are included in the requirement information and the specification information, the technical spirit of the present disclosure may be applied to various specifications or requirements necessary for utilizing a quantum computer. In one example, the quantum computer platform 10 may receive regional information indicating a region in which a quantum computer is located from the quantum computer, and may provide the regional information to the user, thereby allowing the user to select the quantum computer in consideration of various security issues or geographic issues.

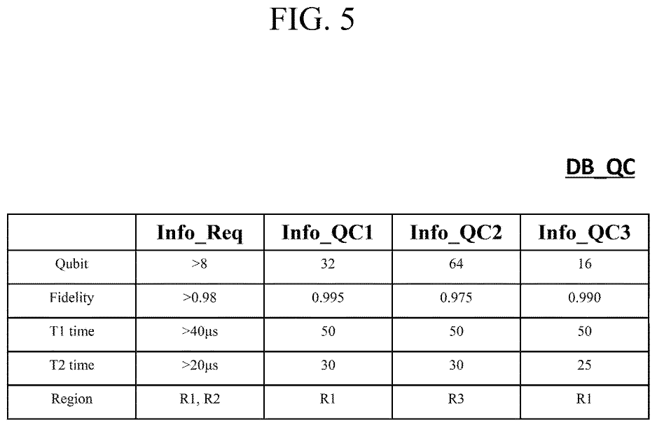

FIG. 5 is a table illustrating a quantum computer database according to an exemplary embodiment of the present disclosure.

Referring to FIG. 5, the quantum computer database DB_QC may include requirement information Info_Req and specification information Info_QC1 to Info_QC3. The quantum computer platform 10 may obtain, as a required number of qubits, greater than 8 qubits, as required fidelity information, greater than 0.98, as a required T1 time, greater than 40 μs, as a required T2 time, greater than 40 μs, and as required regional information, a first region R1 and a second region R2.

The quantum computer platform 10 may receive, using the specification information Info_QC1 to Info_QC3, a provided number of qubits, device fidelity information, a device T1 time, a device T2 time, and regional information. The quantum computer platform 10 may determine that the first specification information Info_QC1 satisfies all pieces of the requirement information Info_Req. The quantum computer platform 10 may determine that, among the second specification information Info_QC2, the device fidelity information 0.975 and the device regional information R3 do not satisfy the requirement information Info_Req. The quantum computer platform 10 may determine that the third specification information Info_QC3 satisfies all pieces of the requirement information Info_Req.

The quantum computer platform 10 may select, as executable quantum computers, quantum computers corresponding to the first specification information Info_QC1 and the third specification information Info_QC3, which satisfy all pieces of the requirement information Info_Req.

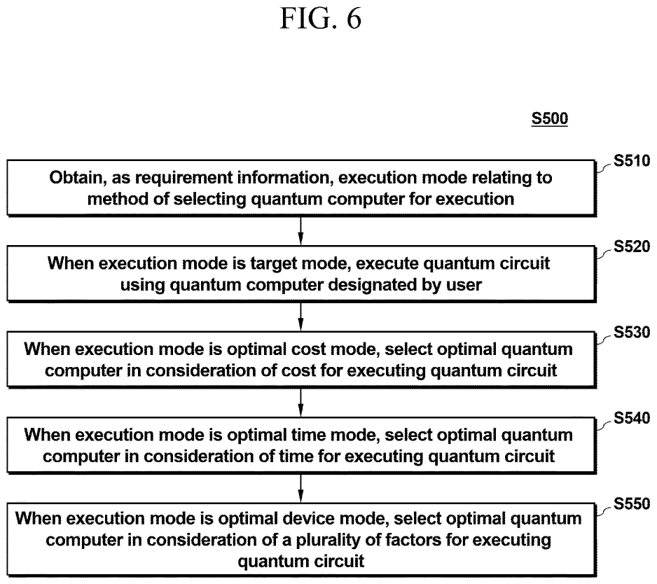

FIG. 6 is a flowchart illustrating a quantum computer scheduling method according to an exemplary embodiment of the present disclosure. More specifically, FIG. 6 illustrates step S500 of selecting an optimal quantum computer in FIG. 2.

Referring to FIG. 6, the quantum computer platform 10 may obtain, as requirement information, an execution mode relating to a method of selecting a quantum computer for execution (S510). When the execution mode is a target mode, the quantum computer platform 10 may execute the quantum circuit using a quantum computer designated by a user (S520). In one example, when the execution mode is a target mode, the quantum computer platform 10 may further receive, from a user, information on a quantum computer for execution, and may perform computation by transmitting the quantum circuit to the corresponding quantum computer.

When the execution mode is an optimal cost mode, the quantum computer platform may select an optimal quantum computer in consideration of a cost for executing the quantum circuit (S530). When the execution mode is an optimal time mode, the quantum computer platform 10 may select an optimal quantum computer in consideration of a time for executing the quantum circuit (S540). When the execution mode is an optimal device mode, the quantum computer platform 10 may select an optimal quantum computer in consideration of a plurality of factors for executing the quantum circuit (S550).

According to one embodiment of the present disclosure, by receiving an execution mode from a user and selecting an optimal quantum computer based on the execution mode, an optimal quantum computer corresponding to an intention of the user may be selected.

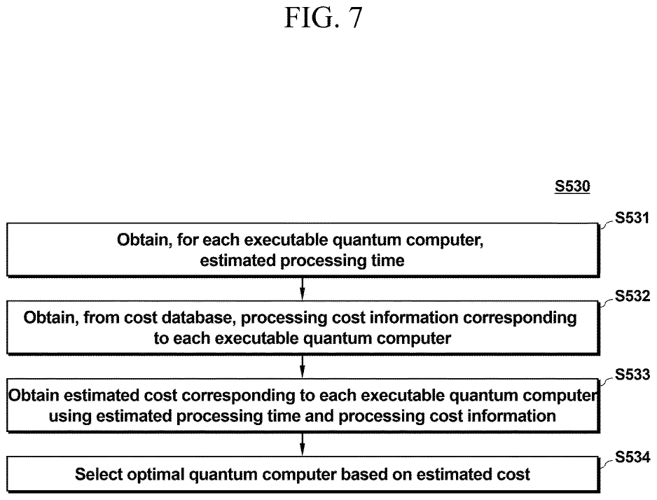

FIG. 7 is a flowchart illustrating a quantum computer scheduling method according to an exemplary embodiment of the present disclosure. More specifically, FIG. 7 illustrates step S530 of selecting an optimal quantum computer when the execution mode of FIG. 6 is an optimal cost mode.

Referring to FIG. 7, the quantum computer platform 10 may obtain, for each executable quantum computer, estimated processing time (S531). Because quantum computers may execute a quantum circuit in various manners, processing time required to process the quantum circuit may also vary. The quantum computer platform 10 may obtain, for each executable quantum computer, estimated processing time obtained by predicting processing time for the executable quantum computer.

The quantum computer platform 10 may obtain, from a cost database, processing cost information corresponding to each executable quantum computer (S532). Because quantum computers may have different specifications, processing costs required for processing may differ from one another, and, in general, a processing cost may be determined as a cost per unit time. The quantum computer platform 10 may store, in advance, processing costs obtained by requesting the same from quantum computers in the cost database and, when executable quantum computers are selected, may obtain processing cost information corresponding thereto from the cost database.

The quantum computer platform 10 may obtain estimated cost corresponding to each executable quantum computer using the estimated processing time and the processing cost information (S533). In one embodiment, the estimated cost may be a total cost incurred in using a quantum computer to process the quantum circuit and, in one example, may be determined based on a value obtained by multiplying the estimated processing time by the processing cost.

The quantum computer platform 10 may select an optimal quantum computer based on the estimated cost (S534). In one example, the quantum computer platform 10 may determine, as the optimal quantum computer, a quantum computer having a lowest estimated cost.

According to one embodiment of the present disclosure, the quantum computer scheduling method may obtain an estimated cost based on the estimated processing time and the processing cost information and may determine an optimal quantum computer based thereon, thereby recommending, when a user intends to use a most cost-effective quantum computer, a quantum computer requiring the lowest cost and, accordingly, a quantum computer matching the user's intention.

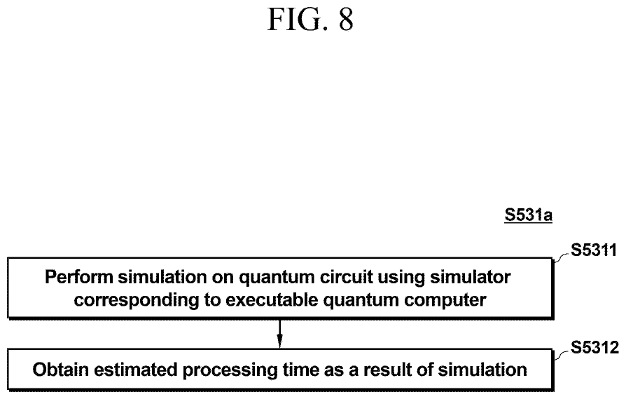

FIG. 8 is a flowchart illustrating a quantum computer scheduling method according to an exemplary embodiment of the present disclosure. More specifically, FIG. 8 illustrates one embodiment S531a of step S531 of obtaining estimated processing time in FIG. 7.

Referring to FIG. 8, the quantum computer platform 10 may perform a simulation on a quantum circuit using a simulator corresponding to an executable quantum computer (S5311), and may obtain estimated processing time as a result of the simulation (S5312).

In one embodiment, the quantum computer platform 10 may include, for each quantum computer, a software-based quantum simulator and a hardware-based quantum simulator, each being a software or hardware system designed to simulate an operating principle of quantum computing or a quantum algorithm, and may include, for example, a Qasm simulator, a Statevector simulator, a Unitary simulator, a QPlayer simulator, an optical-based simulator, and a superconducting-circuit simulator.

According to one embodiment of the present disclosure, the quantum computer platform 10 may obtain estimated processing time by performing a simulation using a particular simulator corresponding to an executable quantum computer, such that estimated processing time suitable for the quantum computer may be obtained. As a result, accurate time may be predicted when predicting the estimated processing time, and, when a processing cost is calculated using the same, an accurate cost may be calculated.

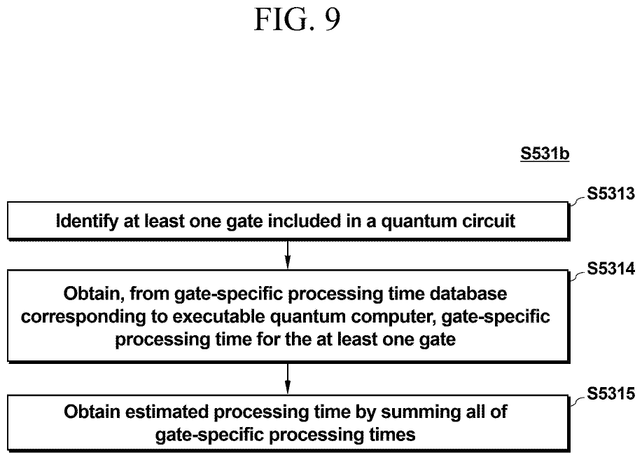

FIG. 9 is a flowchart illustrating a quantum computer scheduling method according to an exemplary embodiment of the present disclosure. More specifically, FIG. 9 illustrates one embodiment S531b of step S531 of obtaining estimated processing time in FIG. 7.

Referring to FIG. 9, the quantum computer platform 10 may identify at least one gate included in a quantum circuit (S5313). In one example, the quantum computer platform may obtain a type and the number of gates included in the quantum circuit received from a user.

The quantum computer platform 10 may obtain, from a gate-specific processing time database corresponding to an executable quantum computer, gate-specific processing time for the at least one gate included in the quantum circuit (S5314). In one example, the quantum computer platform 10 may obtain the gate-specific processing time database by collecting, for each quantum computer, time required to process a single gate according to gate type. The quantum computer platform 10 may obtain the gate-specific processing time for the gates included in the quantum circuit by searching, in the gate-specific processing time database, for the gates identified in step S5313.

The quantum computer platform 10 may obtain estimated processing time by summing all of the obtained gate-specific processing times (S5315).

In an example in which the quantum circuit includes a Y gate and a Z gate, when it is confirmed from the gate-specific processing time database corresponding to the executable quantum computer that a first time is required for the Y gate and a second time is required for the Z gate, the quantum computer platform 10 may obtain, as the estimated processing time, a time obtained by summing the first time and the second time.

According to one embodiment of the present disclosure, estimated processing time may be obtained in a simple manner by merely identifying gates in a quantum circuit and obtaining, as the estimated processing time, a value obtained by summing gate-specific processing times corresponding thereto, without requiring complex operations such as simulation to be performed. As a result, the estimated processing time and a processing cost using the same may be readily calculated.

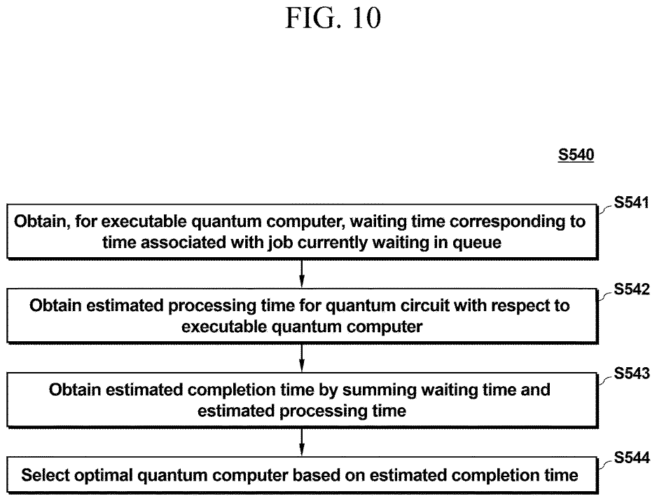

FIG. 10 is a flowchart illustrating a quantum computer scheduling method according to an exemplary embodiment of the present disclosure. More specifically, FIG. 10 illustrates step S540 of selecting an optimal quantum computer when the execution mode in FIG. 6 is an optimal time mode.

Referring to FIG. 10, the quantum computer platform 10 may obtain, for an executable quantum computer, waiting time corresponding to time associated with a job currently waiting in a queue (S541). In one example, the quantum computer platform 10 may obtain the waiting time by transmitting a query to an API of the executable quantum computer.

The quantum computer platform 10 may obtain estimated processing time for a quantum circuit with respect to the executable quantum computer (S542). In one embodiment, the quantum computer platform 10 may obtain the estimated processing time based on the methods described above with reference to FIGS. 8 and 9.

The quantum computer platform 10 may obtain estimated completion time by summing the waiting time and the estimated processing time (S543), and may select an optimal quantum computer based on the estimated completion time (S544). In one example, the quantum computer platform 10 may select, as the optimal quantum computer, a quantum computer having a shortest estimated completion time.

According to one embodiment of the present disclosure, the quantum computer scheduling method may calculate estimated completion time by considering not only estimated processing time but also waiting time, and, as a result, may select an optimal quantum computer in consideration of total time actually required to process a quantum circuit.

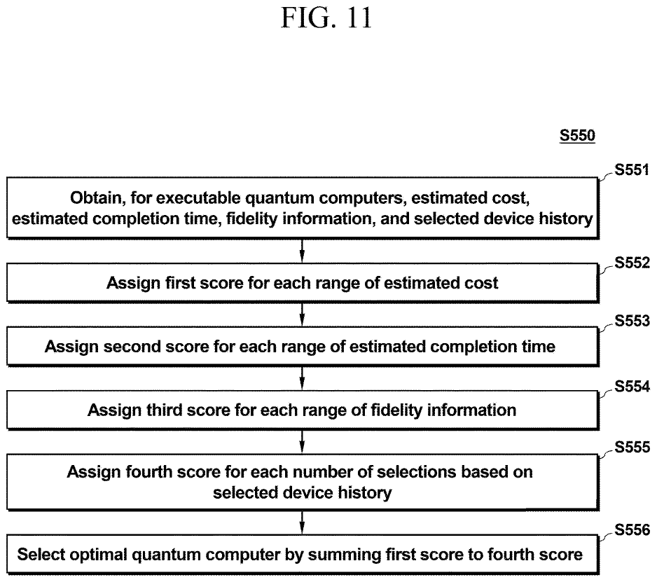

FIG. 11 is a flowchart illustrating a quantum computer scheduling method according to an exemplary embodiment of the present disclosure. More specifically, FIG. 11 illustrates step S550 of selecting an optimal quantum computer when the execution mode in FIG. 6 is an optimal device mode.

Referring to FIG. 11, the quantum computer platform 10 may obtain, for executable quantum computers, estimated cost, estimated completion time, fidelity information, and selected device history (S551). In one embodiment, the quantum computer platform 10 may obtain the estimated cost according to the method described above with reference to FIG. 7, obtain the estimated completion time according to the method described above with reference to FIG. 10, obtain the fidelity information from the quantum computers, and obtain selected device history (e.g., information on which quantum computers have been selected by a user in the past) based on a database for the user.

The quantum computer platform 10 may assign a first score for each range of the estimated cost (S552). In one example, the quantum computer platform 10 may assign a higher first score as the estimated cost decreases.

The quantum computer platform 10 may assign a second score for each range of the estimated completion time (S553). In one example, the quantum computer platform 10 may assign a higher second score as the estimated completion time decreases.

The quantum computer platform 10 may assign a third score for each range of the fidelity information (S554). In one example, the quantum computer platform 10 may assign a higher third score as the fidelity increases.

The quantum computer platform 10 may assign a fourth score for each number of selections based on the selected device history (S555). In one example, the quantum computer platform 10 may assign a higher fourth score as the number of selections increases.

The quantum computer platform 10 may select an optimal quantum computer by summing the first score to the fourth score (S556).

According to one embodiment of the present disclosure, the quantum computer scheduling method may determine an optimal quantum computer based on a plurality of factors, and, as a result, an optimal quantum computer reflecting various factors may be determined. Although FIG. 11 illustrates an example in which fidelity information is included, various types of information on quantum computer specifications, such as a T1 time and a T2 time, may be used instead.

According to one embodiment of the present disclosure, the quantum computer scheduling method may determine an optimal quantum computer in an optimal device mode by considering selected device history, and, as a result, may assign a higher score to a quantum computer frequently used by a user, thereby enabling score assignment reflecting a user's intention of use.

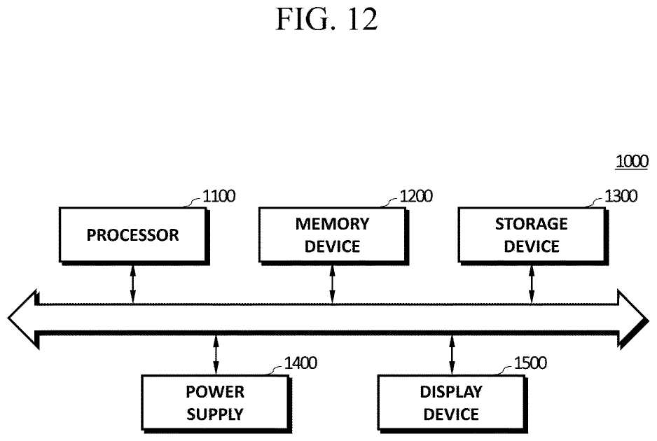

FIG. 12 is a block diagram illustrating a computing system according to an exemplary embodiment of the present disclosure.

Referring to FIG. 12, the computing system 1000 may constitute the quantum computer platform 10 or the user terminal 20, and may include a processor 1100, a memory device 1200, a storage device 1300, a power supply 1400, and a display device 1500. Meanwhile, although not shown in FIG. 12, the computing system 1000 may further include ports capable of communicating with a video card, a sound card, a memory card, a USB device, or other electronic devices.

As described above, the processor 1100, the memory device 1200, the storage device 1300, the power supply 1400, and the display device 1500 included in the computing system 1000 may constitute any one of the quantum computer platforms 10 according to embodiments of the technical spirit of the present invention, and may perform the quantum computer scheduling method. More specifically, the processor 1100 may perform the quantum computer scheduling method described above with reference to FIGS. 1 to 11 by controlling the memory device 1200, the storage device 1300, the power supply 1400, and the display device 1500.

The processor 1100 may perform specific calculations or tasks. According to an embodiment, the processor 1100 may be a microprocessor or a central processing unit (CPU). The processor 1100 may communicate with the memory device 1200, the storage device 1300, and the display device 1500 through a bus such as an address bus, a control bus, and a data bus. According to an embodiment, the processor 1100 may also be connected to an expansion bus such as a Peripheral Component Interconnect (PCI) bus.

The memory device 1200 may store data required for operation of the computing system 1000. For example, the memory device 1200 may be implemented as DRAM, mobile DRAM, SRAM, PRAM, FRAM, RRAM, and/or MRAM. The storage device 1300 may include a solid state drive, a hard disk drive, a CD-ROM, or the like. The storage device 1300 may store a program relating to the quantum computer scheduling method described above with reference to FIGS. 1 to 11, application program data, system data, operating system data, and the like.

The display device 1500 may serve as an output means for providing a notification to a user and may display and provide information on the quantum computer scheduling method to the user or the like. The power supply 1400 may supply an operating voltage required for operation of the computing system 1000.

As described above, exemplary embodiments have been disclosed in the drawings and specification. Although specific terms have been used herein to describe the embodiments, such terms are used only for the purpose of describing the technical spirit of the present invention and are not intended to limit the meaning thereof or to limit the scope of the present invention set forth in the claims. Accordingly, those of ordinary skill in the art will understand that various modifications and equivalent other embodiments may be made thereto. Therefore, the true technical scope of protection of the present invention should be defined by the technical spirit of the appended claims.

What is claimed is:

1. A quantum computer scheduling method performed by at least one processor, the method comprising:
collecting specification information on a plurality of quantum computers;
receiving, from a user, an execution request for a quantum circuit;
obtaining requirement information from the execution request;
selecting at least one executable quantum computer from among the plurality of quantum computers by comparing the requirement information with the specification information;
selecting an executing quantum computer from among the at least one executable quantum computer; and
executing the quantum circuit by using the executing quantum computer.

2. The quantum computer scheduling method of claim 1, wherein the quantum circuit comprises:
a first quantum line representing a quantum state of a first qubit;
a second quantum line representing a quantum state of a second qubit; and
a quantum gate configured to perform an operation on at least one of the first qubit and the second qubit.

3. The quantum computer scheduling method of claim 2, wherein the quantum gate comprises:
a Pauli gate for exchanging state probabilities corresponding to “0” or “1” of a qubit or changing a probability amplitude or a probability phase;
a Hadamard gate for fixing a qubit in a superposition state of “0” and “1”;
a CNOT gate for placing a plurality of qubits in an entangled state;
a SWAP gate for swapping states of a plurality of qubits;
a Toffoli gate for inverting a state of a third qubit based on states of a first qubit and a second qubit; and
a Fredkin gate for swapping states of a second qubit and a third qubit based on a state of a first qubit.

4. The quantum computer scheduling method of claim 1,
wherein the requirement information includes an execution mode relating to a method of selecting a quantum computer for execution, and
wherein the execution mode comprises:
a target mode configured to receive, from a user, information on a quantum computer for execution;
an optimal cost mode configured to select the executing quantum computer in consideration of a cost for executing the quantum circuit;
an optimal time mode configured to select the executing quantum computer in consideration of a time for executing the quantum circuit; and
an optimal device mode configured to select the executing quantum computer in consideration of a plurality of factors for executing the quantum circuit.

5. The quantum computer scheduling method of claim 4, wherein, when the execution mode is the optimal cost mode, selecting the executing quantum computer from among the at least one executable quantum computer comprises:
obtaining, for each of the at least one executable quantum computer, estimated processing time for the quantum circuit;
obtaining, from a cost database, processing cost information corresponding to each of the at least one executable quantum computer;
obtaining, using the estimated processing time and the processing cost information, an estimated cost corresponding to each of the at least one executable quantum computer; and
selecting the executing quantum computer based on the estimated cost.

6. The quantum computer scheduling method of claim 5, wherein the obtaining of the estimated processing time for the quantum circuit for each of the at least one executable quantum computer comprises:
performing a simulation on the quantum circuit using a simulator corresponding to the at least one executable quantum computer; and
obtaining the estimated processing time as a result of the simulation.

7. The quantum computer scheduling method of claim 5, wherein the obtaining of the estimated processing time for the quantum circuit for each of the at least one executable quantum computer comprises:
identifying at least one gate included in the quantum circuit;
obtaining, from a gate-specific processing time database corresponding to the at least one executable quantum computer, gate-specific processing time for the at least one gate; and
obtaining the estimated processing time by summing all of the gate-specific processing times.

8. The quantum computer scheduling method of claim 4, wherein, when the execution mode is the optimal time mode, selecting the executing quantum computer from among the at least one executable quantum computer comprises:
obtaining, for each of the at least one executable quantum computer, waiting time corresponding to time associated with a job waiting in a current queue;
obtaining, for each of the at least one executable quantum computer, estimated processing time for the quantum circuit;
obtaining estimated completion time by summing the waiting time and the estimated processing time; and
selecting the executing quantum computer based on the estimated completion time.

9. The quantum computer scheduling method of claim 4, wherein, when the execution mode is the optimal device mode, selecting the executing quantum computer from among the at least one executable quantum computer comprises:
obtaining, for each of the at least one executable quantum computer, estimated cost;
obtaining, for each of the at least one executable quantum computer, estimated completion time;
obtaining, for each of the at least one executable quantum computer, fidelity information;
obtaining, for each of the at least one executable quantum computer, selected device history indicating devices previously selected by the user; and
selecting the executing quantum computer based on the estimated cost, the estimated completion time, the fidelity information, and the selected device history.

10. The quantum computer scheduling method of claim 9, wherein the selecting of the executing quantum computer based on the estimated cost, the estimated completion time, the fidelity information, and the selected device history comprises:
assigning a first score for each range of the estimated cost;
assigning a second score for each range of the estimated completion time;
assigning a third score for each range of the fidelity information;
assigning a fourth score for each number of selections based on the selected device history; and
selecting the executing quantum computer based on a summed score for the first score to the fourth score.

11. The quantum computer scheduling method of claim 1, wherein the selecting of the at least one executable quantum computer comprises:
obtaining, from the plurality of quantum computers, regional information indicating regions in which the plurality of quantum computers are located; and
providing the regional information to a user.

12. The quantum computer scheduling method of claim 1, wherein the selecting of the at least one executable quantum computer comprises:
obtaining, as the requirement information, a required number of qubits, required fidelity information, a required T1 time, and a required T2 time;
obtaining, as the specification information, a provided number of qubits, device fidelity information, a device T1 time, and a device T2 time; and
selecting, as the at least one executable quantum computer, a quantum computer in which the provided number of qubits, the device fidelity information, the device T1 time, and the device T2 time satisfy the required number of qubits, the required fidelity information, the required T1 time, and the required T2 time, respectively.
